(19) United States
(12) Patent Application Publication
(10) Pub. No.: US 2020/0325953 A1
(43) Pub. Date: Oct. 15, 2020

(54) DAMPER DEVICE FOR DAMPING THE MOVEMENT OF A COMPONENT AND COVER WITH SUCH A DEVICE

(71) Applicant: ILLINOIS TOOL WORKS INC., Glenview, IL (US)

(72) Inventor: Sophia WALTER, Schweinfurt (DE)

(21) Appl. No.: 16/821,422

(22) Filed: Mar. 17, 2020

(30) Foreign Application Priority Data
Apr. 12, 2019 (DE) 10 2019 109 696.0

(51) Int. Cl. F16F 9/16

(52) U.S. Cl. CPC F16F 9/16; F16F 2230/007; F16F 2230/0076; F16F 2228/08

(57) ABSTRACT

A damper device (100), for damping the movement of a component, has a device housing (110) and a spring (120) which is fastened by a first end (121) to the device housing (110) and by a second end (122) to a driver element (140). The spring, in a tensioned state, pretensions the driver element (140) in terms of rotation. The driver element (140) is designed such that, during a rotational movement about an axis of rotation, it carries along a pivoting element (150) and, in the process, sets the latter into a rotational movement about the axis of rotation relative to the device housing. The pivoting element is connected to a damper (130). The damper device has a stop element (111) which is designed such that it restricts or limits the rotational movement of the driver element without restricting or limiting the rotational movement of the pivoting element.

### TECHNICAL FIELD

The present invention relates to a damper device for damping the movement of a component, for example a covering. The invention also relates to a cover or covering which has such a damper device.

### BACKGROUND

Such dampers are used, for example, to provide damped driving action for components in the interior of a car, for example in storage compartments, in particular coverings, flaps or handles there. Furthermore, such dampers are also used in the exterior region of cars, for example for fuel filler compartments or charging compartments. A spring element provides pretensioning, by means of which the component is moved in a damped manner in a first direction for example following release of a locking means. The damper housing often contains a damper fluid, for example a silicone fluid, in which a damper element moves. Interaction with the damper fluid results in the movement of the component being damped.

In particular, in the case of known applications, a damper or damper element is active and harmonizes a spring driven movement over the entire movement region.

Components having such damper devices usually have just two specific positions. In the case of a flap, these positions would be, for example, the closed position and the open position of the flap. As a result, the possible uses of the component are restricted.

### SUMMARY

Proceeding from the above, it is therefore the object of the invention to specify a damper device for damping the movement of a component, and also a covering which has such a damper device, by means of which the aforementioned disadvantages of the prior art are overcome. In particular, it is the object of the present invention to specify a damper device for damping the movement of a component, and also a covering which has such a damper device, by means of which a wider range of possible uses is provided for the component.

The solution according to the invention consists in specifying a damper device for damping the movement of a component, in particular a component in or on a car, which has a device housing and a spring which is fastened by a first end to the device housing and to a second end to a driver element, wherein the spring in a tensioned state pretensions the driver element in terms of rotation, wherein the driver element is designed in such a manner that, during a rotational movement about an axis of rotation, it carries along a pivoting element and, in the process, sets the latter into a rotational movement about the axis of rotation relative to the device housing, wherein the pivoting element is connected to a damper which damps the rotational movement of the pivoting element relative to the device housing, and wherein the damper device furthermore has a stop element which is designed in such a manner that it restricts or limits the rotational movement of the driver element without restricting or limiting the rotational movement of the pivoting element.

The object is achieved satisfactorily by the damper device according to the invention.

The axis of rotation of the driver element here is preferably coaxial in relation to the axis of rotation of the pivoting element.

Pretensioning in terms of rotation is understood to mean spring pretensioning which, when tension is relieved, results in the driver element rotating about the axis of rotation.

The component can be a component which is arranged in the interior (for example a covering, flap or handle) or a component which is arranged in the exterior region of the car (for example a fuel filler compartment or charging compartment).

If the component is a pivotable flap, the pivot axis of the flap runs preferably coaxially in relation to the axis of rotation of the driver element, and also of the pivoting element.

In the case of the damper device according to the invention, the damper is not connected directly to the spring, i.e. it is not directly fastened to the spring or engaged therewith. Rather than damping the movement of the spring directly, the damper damps the movement of the pivoting element, which is made to move by means of the spring, and via the driver element.

The pivoting element has a first movement region, in which the pivoting element is connected to the spring via the driver element, i.e. force can be transmitted from the spring to the pivoting element. This first movement region corresponds to that of a conventional damper device. The spring pretensions the driver element in a movement direction (first direction (of rotation)) which causes the component to open. In the first movement region, for example movement can take place manually in the opposite direction (second direction (of rotation)) counter to the pretensioning of the spring (and the damper).

The damper device also has a second movement region, in which the pivoting element is not connected to the spring via the driver element.

The first movement region extends, for example, from 0° to 60° and the second movement region extends from 60° to 180°. Depending on the case in hand, however, some other distribution is also possible, and conceivable, here. The first and/or second movement region are/is predetermined here via the position of the stop element.

From the open state (end of the first movement region), the component can be moved manually further into the second movement region and thus be opened wider, i.e. the pivoting element can be moved manually further in the first direction, wherein the driver element remains in the position in which it has been stopped by the stop element. In the second movement region, work has to be performed only counter to the resistance of the damper, which is coupled to the pivoting element.

It is therefore possible, in addition to the normal open position (end of the first movement region), into which the component is moved by the pretensioning force of the spring, for the component to be moved (manually) into a number of further positions and, with the damper being adjusted accordingly, retained there. This gives rise to considerably more possible uses than in the case of conventional devices.

According to an advantageous development of the invention, the stop element is a stop projection protruding outward radially from the device housing.

In other words, the stop element is part of the device housing or is fastened thereto.

According to an advantageous development of the invention, the driver element has an at least substantially cylindrical base region and a driver projection protruding outward radially therefrom.

According to an advantageous development of the invention, the driver projection extends axially in such a manner that it can be brought into contact with the stop element and the pivoting element.

The axial direction of extent here runs along the axis of rotation of the driver element.

In this context, can be brought into contact means that the corresponding components touch such that force can be transmitted between them. Upon contact of the driver projection with the pivoting element, the rotational movement of the driver projection is transmitted to the pivoting element. Upon contact of the driver projection with the stop projection of the stop element, the spring driven rotational movement of the driver projection, and thus also of the pivoting element, is stopped.

The components have to extend axially in such a manner as to form an axial region of overlap, which serves as a contact region.

According to an advantageous development of the invention, the pivoting element is a pivot lever.

According to an advantageous development of the invention, the damper has a damper housing and a rotary piston accommodated therein at least in certain regions.

The axis of rotation of the rotary piston here is formed coaxially in relation to the axis of rotation of the pivoting element and of the driver element.

Forming the damper with the damper housing and rotary piston is a particularly practical configuration in which the damper housing delimits a for example substantially cylindrical cavity, in which a substantially likewise cylindrical rotary piston is mounted in a rotatable manner.

According to an advantageous development of the invention, the damper furthermore has a sealing element, preferably in the form of a radial seal, particularly preferably in the form of an O ring, which is arranged between the rotary piston and the damper housing.

According to an advantageous development of the invention, a damper medium is arranged between the rotary piston and the damper housing and damps a rotational movement of the rotary piston relative to the damper housing.

Of course, this damping medium also damps a rotational movement of the damper housing relative to the rotary piston. Consequently, it is also possible for the damper housing to be arranged in a movable manner.

Movement of the rotary piston in the damper medium can cause shearing of the damper medium. The movement of the rotary piston in the damper housing is thus damped in a manner known per se. A corresponding component movement is also damped as a result.

The damper medium can be, in particular, a damper fluid, for example a silicone fluid.

According to an advantageous development of the invention, the pivoting element is fastened to the rotary piston, preferably at an end of the rotary piston that faces away from the damper housing.

According to an advantageous development of the invention, the rotary piston is held axially in the damper housing by means of a cover.

According to an advantageous development of the invention, the spring is accommodated at least in certain regions, preferably completely, in the device housing.

In other words, the outer shape of the device housing (for example length or circumference or width) depends on the spring used. It is therefore possible to use different springs to configure the outer dimensioning (of the device housing) for different uses.

According to an advantageous development of the invention, the spring is a leg spring or a helical torsion spring.

The advantage in using a leg spring is that a comparatively short housing is sufficient to ensure the necessary pretensioning force of the spring.

According to an advantageous development of the invention, the spring is a torsion bar spring or a torsion bar.

The torsion bar spring here can be a single piece element or a component which is made up of a number of spring elements.

The pretensioning takes place in a straightforward manner by virtue of the spring being rotated. The spring itself is relatively narrow, and a narrow device housing is made possible as a result.

Overall, a torsion spring can be used to achieve a narrow, long housing and a leg spring can be used to achieve a short, wide housing. It is therefore possible for the damper device to be adapted to the predetermined amount of installation space.

Further configurations with other drive springs, for example rolling action springs or meander shaped springs, are, of course, conceivable.

According to an advantageous development of the invention, the component is a flap or a covering which is connected to the pivoting element. The pivot axis of the flap here is coaxial in relation to the aforementioned axes of rotation. The flap or covering can be, for example, the flap or covering of a storage compartment, of an ashtray or of a mirror covering.

The object of the present invention is also achieved by a covering which has one of the aforementioned damper devices.

It is, of course, the case here that the advantages which have already been mentioned also apply to such a covering.

### BRIEF DESCRIPTION OF THE DRAWINGS

The invention will be explained in more detail hereinbelow by way of the description of exemplary embodiments and with reference to the accompanying drawings, in which:

FIG. 1 shows a schematic plan view of a damper device according to the first embodiment of the present invention;

FIG. 2 shows a schematic plan view of a damper device according to a second embodiment of the present invention;

FIGS. 3A-3E show plan views of the damper device according to the second embodiment of the present invention in different positions;

FIG. 4 shows a cross sectional view of the damper device according to the first embodiment of the present invention; and

FIG. 5 shows a cross sectional view of a damper device according to the second embodiment.

### DETAILED DESCRIPTION

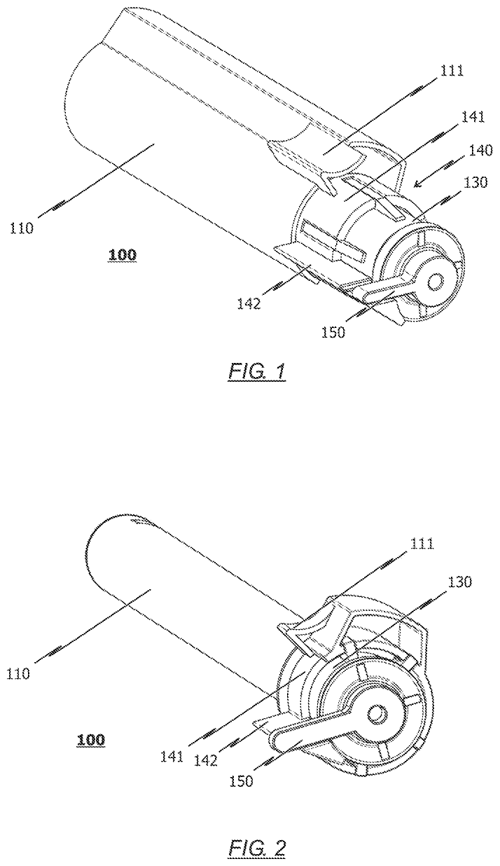

Reference will be made hereinbelow first of all to FIG. 1, which shows a schematic plan view of a damper device 100 according to a first embodiment of the present invention.

The damper device 100 has a device housing 110 with a stop element 111 fastened thereto.

The stop element 111 protrudes radially outward from the device housing and is designed in the form of a stop projection. The stop element 111 also protrudes axially, at one end of the device housing 110, in the direction of a driver element 140.

The driver element 140 is arranged adjacent to the one end of the device housing 110.

The driver element 140 has a substantially cylindrical base region 141 and a driver projection 142.

The driver projection 142 extends radially outward from the base region 141 and forms a contact surface which, when the driver element 140 rotates relative to the device housing 110, comes into contact with the stop element 111 (in this case after 60°).

The contact surface here is a first contact region of the driver projection 142, said first contact region being arranged at an end of the driver projection 142 that is directed toward the device housing 110.

A second contact region is located at the opposite end of the driver projection 142, and said second contact region comes into contact with a pivoting element 150. The figures illustrate this second contact region as being set back at a somewhat lower level than the rest of the driver projection 142.

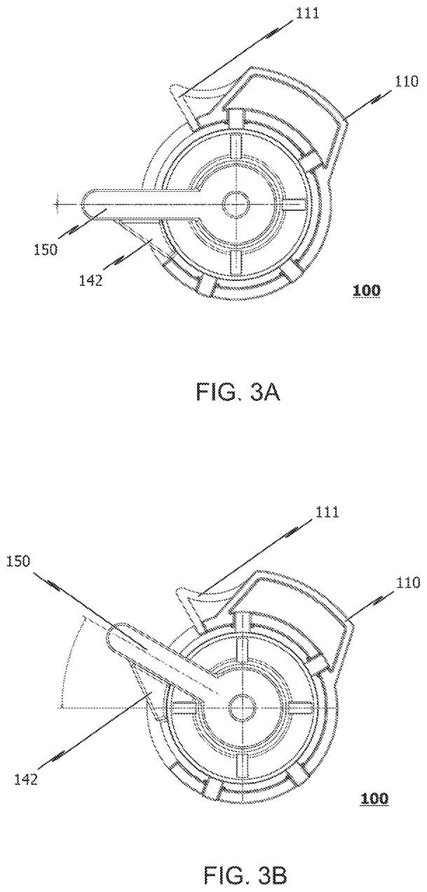

FIGS. 1 and 2 illustrate the damper device 100 in a position in which the driver element 140, more specifically the driver projection 142, is in contact with the pivoting element 150. In other words, the corresponding elements tough and force or movement can be transmitted between them.

When the driver element 140 rotates in the clockwise direction in FIG. 1 or 2, the driver element 140 carries along the pivoting element 150. In other words, the rotational movement of the driver element 140 about an axis of rotation is transmitted to the pivoting element 150 such that the latter likewise rotates about the axis of rotation. The axes of rotation here are coaxial in relation to one another, wherein the axial direction of the device housing 110 or of the damper device 100 runs along said axis or axes of rotation.

The driver projection 142 can rotate about its axis of rotation to the extent where (by so many degrees until) it strikes against the stop element 111, as a result of which the rotational movement of the driver element 140 is stopped.

The damper device 100 also has a damper 130, which damps the movement of the pivoting element 150 relative to the device housing 110.

Of the damper 130, FIGS. 1 and 2 show only an outer at least substantially cylindrical damper housing.

If the component is, for example, a pivotable flap, the rotational movement of the pivoting element 150 in a first direction (in FIG. 1 in the clockwise direction) can cause the flap or covering to pivot into the open position.

It is possible for this purpose, in a particularly straightforward manner, to orient the axes of rotation of the components of the damper device 100 coaxially in relation to a pivot axis of the component, for example of the covering. From the open state of the covering, the latter can be opened wider on a manual basis, i.e. the pivoting element 150 can be moved further in the first direction (of rotation) on a manual basis, wherein the driver element 140 remains in its (stopped) position.

It is still necessary here for work to be performed counter to the resistance of the damper 130, which is coupled to the pivoting element 150. From the open state of the covering, and also from the wider open state, the covering can be closed again manually. The pivoting element 150 here is moved in its second direction of rotation (in FIGS. 1 and 2 in the counterclockwise direction).

It is only when the pivoting element 150 comes into contact again with the driver projection 142 that work has to be performed counter to the spring, the latter then being pretensioned again.

Suitable locking means which, in the locked state, prevent renewed opening of the covering on account of the pretensioning of the spring can be provided on the component.

The damper devices 100 which are illustrated in FIGS. 1 and 2 function in substantially the same way, wherein the damper device 100 which is shown in FIG. 1 has a leg spring arranged in the device housing 110 and the embodiment which is shown in FIG. 2 has a torsion bar spring arranged in the device housing 110.

Accordingly, the device housings 110 in FIGS. 1 and 2 have different outer shapes.

Regardless of this, the aspects which are mentioned in relation to FIG. 1 also apply to the damper device 100 which is illustrated in FIG. 2.

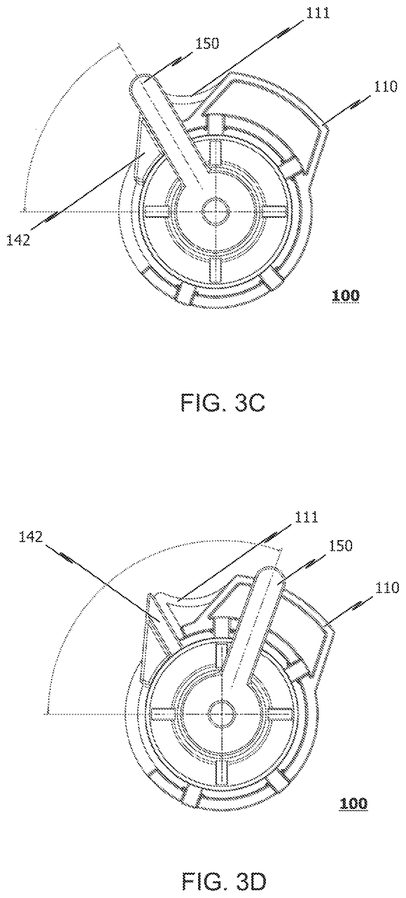

FIGS. 3A to 3D show the damper device 100 in different positions, i.e. with the pivoting element 150 in different positions. In particular, FIGS. 3A to 3D show the damper device 100 according to the second embodiment, i.e. the damper device 100 which is pretensioned by a torsion bar spring.

FIG. 3A shows the damper device 100 in its starting position, in which the driver element 140, and thus the driver projection 142, is pretensioned and is retained in the pretensioned state by suitable locking means of the component (for example of the flap or of the covering).

If these locking means are then disengaged, the rotational pretensioning of the driver element 140 causes the driver projection 142 to move in the clockwise direction of the figures.

FIG. 3B shows a position of the damper device 100 further onward in the first direction of rotation, in the case of which the driver projection 142 and the pivoting element 150 have rotated 30° in the clockwise direction from the position which is shown in FIG. 3A.

As the spring is released of tension, the driver element 140 rotates in the clockwise direction and carries along the pivoting element 150. Of course, it would nevertheless also be possible to have a configuration in which the device 100 rotates in the counterclockwise direction.

FIG. 3C shows a position of the damper device 100 in which the driver projection 142 and the pivoting element 150 have been rotated by 60° in the clockwise direction from the starting position (FIG. 3A).

It can likewise be seen here that, at 60°, the driver projection 142 strikes against the stop element 111 and comes into contact with the same. This means that, in the embodiment which is illustrated in the figures, the driver element 140 cannot rotate beyond 60° in the clockwise direction.

The stop element 111 therefore restricts the region of rotation of the driver element 140. Of course, said region need not be restricted to 60°; rather, it is also possible to predetermine the region at 45°, 90° or some other desired number of degrees.

The first movement region of the pivoting element 150 here is the movement region from 0° to 60°, i.e. in other words the movement region up until the point where the driver projection 142 strikes against the stop element 111.

As can be seen in FIG. 3D, it is possible for the pivoting element 150 to rotate further in the clockwise direction. The pivoting element 150 here has been rotated by 110° in relation to the starting state (FIG. 3A).

Since the driver element 140 is “blocked” by the stop element 111, it is also the case that the pretensioning spring is decoupled from the pivoting element 150. Force between the spring and pivoting element 150 is only ever transmitted via the driver element 140. “Blocking” of the latter (restriction of rotation by the stop element 111) therefore provides for a second movement region of the pivoting element 150 decoupled from the pretensioning spring.

In the first movement region (in this case 0° to 60°), the spring and damper 130 are coupled and both act on the pivoting element 150. In the second movement region (from 60°, in this case up to 180°), it is just the damper 130 which is coupled to the pivoting element 150.

FIG. 3E shows the pivoting element 150 in an end position, in which it has been rotated by 180° from the starting position (FIG. 3A). The end position can be realized, for example, by a further stop, for example on the device housing 110.

In the second movement region, i.e. in the region from 60° to 180°, the pivoting element 150 can be moved preferably only on a manual basis. If the component is, for example, a pivotable flap, it has its open position at 60°, wherein the flap can be opened wider on a manual basis, beyond this 60°, up to 180° (to give a “wider open” position).

If the damper 130 is adjusted, with account being taken of the weight of the flap, such that it counteracts the force to which the device is subjected by gravity, the pivotable flap can be designed such that it can move in a damped manner or can freewheel, or move of its own accord, if “relieved of manual loading” from 60° to 180°.

Although the aforementioned example has been elucidated with reference to a pivotable flap, this should not be regarded as a restriction. It is, of course, the case that this aspect therefore also applies, for example, to other coverings or levers.

If the pivoting element 150 is moved in the second movement direction (i.e. in FIGS. 3A to 3D in the counterclockwise direction), in the second movement region between 180° and 60°, work has to be performed only counter to the damper 130, or the freewheeling damper. In the movement region between 60° and 0°, work has to be performed counter to the damper 130, or the freewheeling damper, and counter to the pretensioning spring. The movement in the second movement direction here causes the pretensioning of the spring in the first movement region.

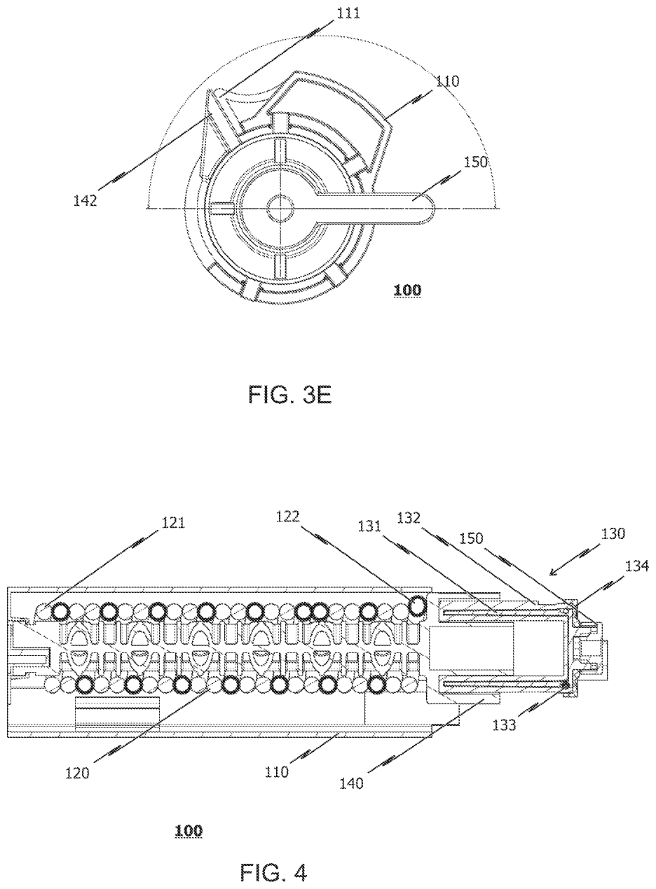

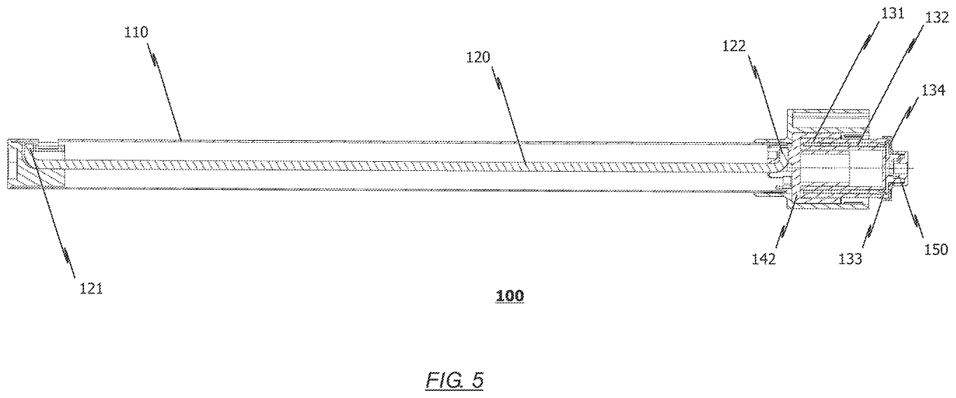

FIG. 4 shows a cross sectional view of the damper device 100 according to the first embodiment, and FIG. 5 shows a cross sectional view of the damper device 100 according to the second embodiment.

In other words, the damper devices 100 which are illustrated in FIGS. 4 and 5 differ predominantly in that FIG. 4 makes use of a leg spring for pretensioning purposes and FIG. 5 makes use of a torsion bar spring for pretensioning purposes. The damper 130 and the functions thereof, however, are the same in both figures.

The device housing 110 contains the spring 120, wherein a first end 121 of the spring 120 is connected to the device housing 110 and a second end 122 of the spring 120 is connected to the driver element 140.

The spring 120 which is shown in FIG. 4 is a leg spring or a helical torsion spring and the spring 120 which is shown in FIG. 5 is a torsion bar spring or a torsion spring.

The device housing 110 is substantially cylindrical, the driver element 140 being arranged at one end, as seen in the axial direction, and being connected to the second end 122 of the spring 120 such that the pretensioning of the spring 120 can cause the driver element 140 to rotate. A damper housing 131 of the damper 130 is accommodated at least in certain regions of the driver element 140. More specifically, the driver element 140 has a recess, which accommodates a hollow cylindrical region of the damper housing 131. The damper 130 furthermore has a rotary piston 132.

The rotary piston 132 has a hollow cylindrical region, which is accommodated at least in part in the damper housing 131.

It is also the case that a cavity is formed between the damper housing 131 and the rotary piston 132, said cavity accommodating a damper medium, for example a damper fluid, such as a silicone fluid.

In order for the damper fluid to be retained between the rotary piston 132 and the damper housing 131, a sealing element 113 in the form of an O ring is also provided, said sealing element providing radial sealing between the rotary piston 132 and the damper housing 131.

At its end that faces away from the damper housing 131, the rotary piston 132 has a region which engages with the pivoting element 150. This results in a movement of the pivoting element 150 being transmitted to the rotary piston 132 and being damped by the damper 130 and/or the damper medium.

The damper also has a cover 134, which holds the rotary piston 132 in the damper housing 131.

The pivoting element 150 can be mounted on the component, for example the flap, and then causes the component to “pivot open”.

Neither the driver projection 142 according to the invention nor the stop element 111 are illustrated in the cross section in FIGS. 4 and 5. However, these are designed, and arranged, as described above in order for it to be possible to perform the function according to the invention.

### LIST OF REFERENCE SIGNS

100 Damper device
110 Device housing
111 Stop element
120 Spring
121 First end
122 Second end
130 Damper
131 Damper housing
132 Rotary piston
133 Sealing element
134 Cover
140 Driver element
141 Base region
142 Driver projection
150 Pivoting element

What is claimed is:

1. A damper device (100) for damping the movement of a component, in particular a component in or on a car, wherein the damper device (100) has a device housing (110) and a spring (120) which is fastened by a first end (121) to the device housing (110) and by a second end (122) to a driver element (140), wherein the spring (120) in a tensioned state pretensions the driver element (140) in terms of rotation, wherein the driver element (140) is designed in such a manner that, during a rotational movement about an axis of rotation, it carries along a pivoting element (150) and, in the process, sets the latter into a rotational movement about the axis of rotation relative to the device housing (110), wherein the pivoting element (150) is connected to a damper (130) which damps the rotational movement of the pivoting element (150) relative to the device housing (110), and wherein the damper device (100) furthermore has a stop element (111) which is designed in such a manner that it restricts or limits the rotational movement of the driver element (140) without restricting or limiting the rotational movement of the pivoting element (150).

2. The damper device (100) as claimed in claim 1, wherein the stop element (111) is a stop projection protruding outward radially from the device housing (110).

3. The damper device (100) as claimed in claim 1, wherein the driver element (140) has an at least substantially cylindrical base region (141) and a driver projection (142) protruding outward radially therefrom.

4. The damper device (100) as claimed in claim 2, wherein the driver projection (142) extends axially in such a manner that it can be brought into contact with the stop element (111) and the pivoting element (150).

5. The damper device (100) as claimed in claim 1, wherein the pivoting element (150) is a pivot lever.

6. The damper device (100) as claimed in claim 1, wherein the damper (130) has a damper housing (131) and a rotary piston (132) accommodated therein at least in certain regions.

7. The damper device (100) as claimed in claim 5, wherein the damper (130) furthermore has a sealing element (133), preferably in the form of a radial seal, particularly preferably in the form of an O ring, which is arranged between the rotary piston (132) and the damper housing (131).

8. The damper device (100) as claimed in claim 6, wherein a damper medium which is arranged between the rotary piston (132) and the damper housing (131) damps a rotational movement of the rotary piston (132) relative to the damper housing (131).

9. The damper device (100) as claimed in claim 5, wherein the pivoting element (150) is fastened to the rotary piston (132), preferably at an end of the rotary piston (132) that faces away from the damper housing (131).

10. The damper device (100) as claimed in claim 9, wherein the rotary piston (132) is held axially in the damper housing (131) by means of a cover (130).

11. The damper device (100) as claimed in claim 1, wherein the spring (120) is accommodated at least in certain regions, preferably completely, in the device housing (110).

12. The damper device (100) as claimed in claim 1, wherein the spring (120) is a leg spring or a helical torsion spring.

13. The damper device (100) as claimed in claim 1, wherein the spring (120) is a torsion bar spring or a torsion bar.

14. The damper device (100) as claimed in claim 1, wherein the component is a flap or a covering which is connected to the pivoting element.

15. A covering, in particular in or on a car, wherein the covering has a damper device (100) as claimed in claim 14.

16. A damper device for damping the movement of a component in or on a car, the damper device comprising:
a device housing;
a driver element;
a pivoting element;
a damper;
a spring which is fastened by a first end to the device housing and by a second end to the driver element, wherein the spring has a tensioned state in which the spring pretensions the driver element, in terms of rotation, wherein the driver element is configured such that, during a rotational movement about an axis of rotation, the driver element carries along the pivoting element and, in the process, sets the picoting element into a rotational movement about the axis of rotation relative to the device housing;
wherein the pivoting element is connected to the damper such that the damper damps the rotational movement of the pivoting element relative to the device housing, and wherein the damper device furthermore has a stop element which is configured such that the stop element restricts or limits the rotational movement of the driver element without restricting or limiting the rotational movement of the pivoting element.

17. The damper device as claimed in claim 16, wherein the stop element is a stop projection protruding outward radially from the device housing.

18. The damper device as claimed in claim 17, wherein the driver element has an at least substantially cylindrical base region and a driver projection protruding outward radially therefrom.
